(19) United States
(12) Patent Application Publication
(10) Pub. No.: US 2025/0031166 A1
(43) Pub. Date: Jan. 23, 2025

(54) METHOD, APPARATUS AND COMPUTER PROGRAM

(71) Applicant: NOKIA TECHNOLOGIES OY, Espoo (FI)

(72) Inventors: Pallab GUPTA, Bangalore (IN); Saubhagya BALIARSINGH, Bengaluru (IN); Saurabh KHARE, Bangalore (IN)

(21) Appl. No.: 18/775,890

(22) Filed: Jul. 17, 2024

(30) Foreign Application Priority Data
Jul. 18, 2023 (IN) 202341048228

(51) Int. Cl. H04W 60/00; H04W 8/18; H04W 76/10; H04W 84/04

(52) U.S. Cl. CPC H04W 60/00; H04W 8/18; H04W 76/10; H04W 84/042

(57) ABSTRACT

There is provided an apparatus comprising: means for receiving, at a target public land mobile network, signalling for establishing a protocol data unit session for a first service for a user equipment, wherein the first service is hostable by the target public land mobile network and a home public land mobile network, and means for causing data associated with the protocol data unit session for the first service to be transferred between the target public land mobile network and a visitor public land mobile network, wherein the user equipment is registered with the visitor public land mobile network.

### CROSS-REFERENCE TO RELATED APPLICATIONS

This application claims priority to Indian application Ser. No. 20/234,1048228, filed Jul. 18, 2023, the entire contents of which are incorporated herein by reference.

### TECHNICAL FIELD

Various example embodiments of this subject disclosure relate to a method, apparatus, and computer program for a wireless communication system.

### BACKGROUND

A communication system may be a facility that enables communication sessions between two or more entities such as user terminals, base stations/access points and/or other nodes by providing carriers between the various entities involved in the communications path. A communication system may be provided, for example, by means of a communication network and one or more compatible communication devices. The communication sessions may comprise, for example, communication of data for carrying communications such as voice, electronic mail (email), text message, multimedia and/or content data, and so on. Non-limiting examples of services provided comprise two-way or multi-way calls, data communication or multimedia services, and access to a data network system, such as the Internet.

### SUMMARY

Several aspects of the various example embodiments are detailed as follows.

According to an aspect, there is provided an apparatus comprising: means for receiving, at a target public land mobile network, signalling for establishing a protocol data unit session for a first service for a user equipment, wherein the first service is hostable by the target public land mobile network and a home public land mobile network; and means for causing data associated with the protocol data unit session for the first service to be transferred between the target public land mobile network and a visitor public land mobile network, wherein the user equipment is registered with the visitor public land mobile network.

In some aspects, the means for receiving comprises: means for receiving, from the home public land mobile network, a network function discovery request.

In some aspects, the apparatus comprises: means for providing, to the visited public land mobile network, information about a session management function of the target public land mobile network for the establishment of the protocol data unit session.

In some aspects, the information about the session management function of the target public land mobile network is provided in an Nnrf_NFDiscovery_Request response message.

In some aspects, the means for receiving comprises: means for receiving, at a session management function of the target public land mobile network from a session management function of the home public land mobile network, a service request message comprising at least one of the following: information associated with the protocol data unit session establishment request, or subscription data associated with the user equipment.

In some aspects, the means for receiving comprises: means for receiving, at a session management function of the target land mobile network, a protocol data unit session establishment request message from a session management function of the home public land mobile network; and wherein the apparatus comprises: means for selecting a user plane function of the target public land mobile network to serve the protocol data unit session; and means for responding to the session management function of the home public land mobile network with an indication of the selected user plane function of the target public land mobile network.

In some aspects, the means for receiving, at a target public land mobile network, signalling for establishing a protocol data unit session for a first service for a user equipment comprises: means for receiving, from the visited public land mobile network, the signalling for establishing a protocol data unit session for a first service for a user equipment.

In some aspects, the apparatus comprises: means for retrieving, from a unified data management function of the home public land mobile network, session management subscription data comprising at least one of the following, per data network name: an indication of whether the data network name supports roaming value added services routing to a target public land mobile network, or an identity of the target public land mobile network.

According to an aspect, there is provided an apparatus comprising: circuitry configured to perform: receiving, at a target public land mobile network, signalling for establishing a protocol data unit session for a first service for a user equipment, wherein the first service is hostable by the target public land mobile network and a home public land mobile network; and circuitry configured to perform: causing data associated with the protocol data unit session for the first service to be transferred between the target public land mobile network and a visitor public land mobile network, wherein the user equipment is registered with the visitor public land mobile network.

According to an aspect, there is provided an apparatus comprising: means for determining whether to route signalling for establishing a protocol data unit session for a first service for a user equipment to a target public land mobile network based on at least one of following: a data network name associated with the first service, subscription data associated with the user equipment, or an identity of a visitor public land mobile network serving the user equipment, wherein the user equipment is registered with a visitor public land mobile network, wherein the first service is hostable by the target public land mobile network and a home public land mobile network; and means for, based on the determining, routing signalling for establishing the protocol data unit session at the target public land mobile network.

In some aspects, the means for routing signalling for establishing the protocol data unit session comprises: means for forwarding, to the target public land mobile network from the visitor public land mobile network, a network function discovery request based on at least one of following: a data network name associated with the first service, subscription data associated with the user equipment, or an identity of a visitor public land mobile network serving the user equipment.

In some aspects, the apparatus comprises: means for using, at a network repository function of the home public land mobile network, a stored configuration comprising an indication of a serving public land mobile network and a data network name mapped to the target public land mobile network.

In some aspects, the apparatus comprises: means for receiving, at a session management function of the home public land mobile network from the visited public land mobile network, a protocol data unit session establishment request for the user equipment; means for, based on the protocol data unit session establishment request, providing, to a session management function of the target public land mobile network, a service request message comprising at least one of the following: information associated with the protocol data unit session establishment request, or subscription data associated with the user equipment.

In some aspects, the apparatus comprises: means for controlling, by a session management function of the home public land mobile network, a user plane function of the target public land mobile network by encapsulating N4 message in a service request message from the session management function of the home public land mobile network to a session management function of the target public land mobile network.

In some aspects, the apparatus comprises: means for storing, at a unified data management function of the home public land mobile network, session management subscription data for the user equipment comprising at least one of the following: a data network name with an indication of support for roaming value added service routing, or a target public land mobile network identity with an indication of support for roaming value added service routing.

In some aspects, the apparatus comprises: means for storing, at a unified data management function of the home public land mobile network, session management function selection subscription data comprising at least one of the following, per data network name: an indication of whether the data network name supports roaming value added services routing to a target public land mobile network, or an identity of the target public land mobile network; and means for providing, based on a received request from a session management function of the target public land mobile network, providing session management function selection subscription data for the user equipment to the target land mobile network.

According to an aspect, there is provided an apparatus comprising: circuitry configured to perform: determining whether to route signalling for establishing a protocol data unit session for a first service for a user equipment to a target public land mobile network based on at least one of following: a data network name associated with the first service, subscription data associated with the user equipment, or an identity of a visitor public land mobile network serving the user equipment, wherein the user equipment is registered with a visitor public land mobile network, wherein the first service is hostable by the target public land mobile network and a home public land mobile network; and circuitry configured to perform: based on the determining, routing signalling for establishing the protocol data unit session at the target public land mobile network.

According to an aspect, there is provided an apparatus comprising: at least one processor, and at least one memory storing instructions that, when executed by the at least one processor, cause the apparatus to perform: receiving, at a target public land mobile network, signalling for establishing a protocol data unit session for a first service for a user equipment, wherein the first service is hostable by the target public land mobile network and a home public land mobile network; and causing data associated with the protocol data unit session for the first service to be transferred between the target public land mobile network and a visitor public land mobile network, wherein the user equipment is registered with the visitor public land mobile network.

In some aspects, the receiving comprises: receiving, from the home public land mobile network, a network function discovery request.

In some aspects, the apparatus is caused to perform: providing, to the visited public land mobile network, information about a session management function of the target public land mobile network for the establishment of the protocol data unit session.

In some aspects, the information about the session management function of the target public land mobile network is provided in an Nnrf_NFDiscovery_Request response message.

In some aspects, the receiving comprises: receiving, at a session management function of the target public land mobile network from a session management function of the home public land mobile network, a service request message comprising at least one of the following: information associated with the protocol data unit session establishment request, or subscription data associated with the user equipment.

In some aspects, the receiving comprises: receiving, at a session management function of the target land mobile network, a protocol data unit session establishment request message from a session management function of the home public land mobile network; and wherein the method comprises: selecting a user plane function of the target public land mobile network to serve the protocol data unit session; and responding to the session management function of the home public land mobile network with an indication of the selected user plane function of the target public land mobile network.

In some aspects, the receiving, at a target public land mobile network, signalling for establishing a protocol data unit session for a first service for a user equipment comprises: receiving, from the visited public land mobile network, the signalling for establishing a protocol data unit session for a first service for a user equipment.

In some aspects, the apparatus is caused to perform: retrieving, from a unified data management function of the home public land mobile network, session management subscription data comprising at least one of the following, per data network name: an indication of whether the data network name supports roaming value added services routing to a target public land mobile network, or an identity of the target public land mobile network.

According to an aspect, there is provided a method comprising: receiving, at a target public land mobile network, signalling for establishing a protocol data unit session for a first service for a user equipment, wherein the first service is hostable by the target public land mobile network and a home public land mobile network; and causing data associated with the protocol data unit session for the first service to be transferred between the target public land mobile network and a visitor public land mobile network, wherein the user equipment is registered with the visitor public land mobile network.

In some aspects, the receiving comprises: receiving, from the home public land mobile network, a network function discovery request.

In some aspects, the method comprises: providing, to the visited public land mobile network, information about a session management function of the target public land mobile network for the establishment of the protocol data unit session.

In some aspects, the information about the session management function of the target public land mobile network is provided in an Nnrf_NFDiscovery_Request response message.

In some aspects, the receiving comprises: receiving, at a session management function of the target public land mobile network from a session management function of the home public land mobile network, a service request message comprising at least one of the following: information associated with the protocol data unit session establishment request, or subscription data associated with the user equipment.

In some aspects, the receiving comprises: receiving, at a session management function of the target land mobile network, a protocol data unit session establishment request message from a session management function of the home public land mobile network; and wherein the method comprises: selecting a user plane function of the target public land mobile network to serve the protocol data unit session; and responding to the session management function of the home public land mobile network with an indication of the selected user plane function of the target public land mobile network.

In some aspects, the receiving, at a target public land mobile network, signalling for establishing a protocol data unit session for a first service for a user equipment comprises: receiving, from the visited public land mobile network, the signalling for establishing a protocol data unit session for a first service for a user equipment.

In some aspects, the method comprises: retrieving, from a unified data management function of the home public land mobile network, session management subscription data comprising at least one of the following, per data network name: an indication of whether the data network name supports roaming value added services routing to a target public land mobile network, or an identity of the target public land mobile network.

According to an aspect, there is provided an apparatus comprising: at least one processor, and at least one memory storing instructions that, when executed by the at least one processor, cause the apparatus to perform: determining whether to route signalling for establishing a protocol data unit session for a first service for a user equipment to a target public land mobile network based on at least one of following: a data network name associated with the first service, subscription data associated with the user equipment, or an identity of a visitor public land mobile network serving the user equipment, wherein the user equipment is registered with a visitor public land mobile network, wherein the first service is hostable by the target public land mobile network and a home public land mobile network; and based on the determining, routing signalling for establishing the protocol data unit session at the target public land mobile network.

In some aspects, the routing signalling for establishing the protocol data unit session comprises: forwarding, to the target public land mobile network from the visitor public land mobile network, a network function discovery request based on at least one of following: a data network name associated with the first service, subscription data associated with the user equipment, or an identity of a visitor public land mobile network serving the user equipment.

In some aspects, the apparatus is caused to perform: using, at a network repository function of the home public land mobile network, a stored configuration comprising an indication of a serving public land mobile network and a data network name mapped to the target public land mobile network.

In some aspects, the apparatus is caused to perform: receiving, at a session management function of the home public land mobile network from the visited public land mobile network, a protocol data unit session establishment request for the user equipment; based on the protocol data unit session establishment request, providing, to a session management function of the target public land mobile network, a service request message comprising at least one of the following: information associated with the protocol data unit session establishment request, or subscription data associated with the user equipment.

In some aspects, the apparatus is caused to perform: controlling, by a session management function of the home public land mobile network, a user plane function of the target public land mobile network by encapsulating N4 message in a service request message from the session management function of the home public land mobile network to a session management function of the target public land mobile network.

In some aspects, the apparatus is caused to perform: storing, at a unified data management function of the home public land mobile network, session management subscription data for the user equipment comprising at least one of the following: a data network name with an indication of support for roaming value added service routing, or a target public land mobile network identity with an indication of support for roaming value added service routing.

In some aspects, the apparatus is caused to perform: storing, at a unified data management function of the home public land mobile network, session management function selection subscription data comprising at least one of the following, per data network name: an indication of whether the data network name supports roaming value added services routing to a target public land mobile network, or an identity of the target public land mobile network; and providing, based on a received request from a session management function of the target public land mobile network, providing session management function selection subscription data for the user equipment to the target land mobile network.

According to an aspect, there is provided a method comprising: determining whether to route signalling for establishing a protocol data unit session for a first service for a user equipment to a target public land mobile network based on at least one of following: a data network name associated with the first service, subscription data associated with the user equipment, or an identity of a visitor public land mobile network serving the user equipment, wherein the user equipment is registered with a visitor public land mobile network, wherein the first service is hostable by the target public land mobile network and a home public land mobile network; and based on the determining, routing signalling for establishing the protocol data unit session at the target public land mobile network.

In some aspects, the routing signalling for establishing the protocol data unit session comprises: forwarding, to the target public land mobile network from the visitor public land mobile network, a network function discovery request based on at least one of following: a data network name associated with the first service, subscription data associated with the user equipment, or an identity of a visitor public land mobile network serving the user equipment.

In some aspects, the method comprises: using, at a network repository function of the home public land mobile network, a stored configuration comprising an indication of a serving public land mobile network and a data network name mapped to the target public land mobile network.

In some aspects, the method comprises: receiving, at a session management function of the home public land mobile network from the visited public land mobile network, a protocol data unit session establishment request for the user equipment; based on the protocol data unit session establishment request, providing, to a session management function of the target public land mobile network, a service request message comprising at least one of the following: information associated with the protocol data unit session establishment request, or subscription data associated with the user equipment.

In some aspects, the method comprises: controlling, by a session management function of the home public land mobile network, a user plane function of the target public land mobile network by encapsulating N4 message in a service request message from the session management function of the home public land mobile network to a session management function of the target public land mobile network.

In some aspects, the method comprises: storing, at a unified data management function of the home public land mobile network, session management subscription data for the user equipment comprising at least one of the following: a data network name with an indication of support for roaming value added service routing, or a target public land mobile network identity with an indication of support for roaming value added service routing.

In some aspects, the method comprises: storing, at a unified data management function of the home public land mobile network, session management function selection subscription data comprising at least one of the following, per data network name: an indication of whether the data network name supports roaming value added services routing to a target public land mobile network, or an identity of the target public land mobile network; and providing, based on a received request from a session management function of the target public land mobile network, providing session management function selection subscription data for the user equipment to the target land mobile network.

According to an aspect, there is provided a computer program comprising instructions, which when executed by an apparatus, cause the apparatus to perform at least the following: receiving, at a target public land mobile network, signalling for establishing a protocol data unit session for a first service for a user equipment, wherein the first service is hostable by the target public land mobile network and a home public land mobile network; and causing data associated with the protocol data unit session for the first service to be transferred between the target public land mobile network and a visitor public land mobile network, wherein the user equipment is registered with the visitor public land mobile network.

According to an aspect, there is provided a computer program comprising instructions, which when executed by an apparatus, cause the apparatus to perform at least the following: determining whether to route signalling for establishing a protocol data unit session for a first service for a user equipment to a target public land mobile network based on at least one of following: a data network name associated with the first service, subscription data associated with the user equipment, or an identity of a visitor public land mobile network serving the user equipment, wherein the user equipment is registered with a visitor public land mobile network, wherein the first service is hostable by the target public land mobile network and a home public land mobile network; and based on the determining, routing signalling for establishing the protocol data unit session at the target public land mobile network.

According to an aspect, there is provided a system comprising: means for determining, at a home public land mobile network, whether to route signalling for establishing a protocol data unit session for a first service for a user equipment to a target public land mobile network based on at least one of following: a data network name associated with the first service, subscription data associated with the user equipment, or an identity of a visitor public land mobile network serving the user equipment, wherein the user equipment is registered with a visitor public land mobile network, wherein the first service is hostable by the target public land mobile network and the home public land mobile network; means I for routing, based on the determining, from the home public land mobile network to target public land mobile network, signalling for establishing the protocol data unit session at the target public land mobile network; and means for causing, at the target public land mobile network, data associated with the protocol data unit session for the first service to be transferred between the target public land mobile network and a visitor public land mobile network, wherein the user equipment is registered with the visitor public land mobile network.

According to an aspect, there is provided a system comprising: a first apparatus comprising: at least one processor, and at least one memory storing instructions that, when executed by the at least one processor, cause the apparatus to perform: determining, at a home public land mobile network, whether to route signalling for establishing a protocol data unit session for a first service for a user equipment to a target public land mobile network based on at least one of following: a data network name associated with the first service, subscription data associated with the user equipment, or an identity of a visitor public land mobile network serving the user equipment, wherein the user equipment is registered with a visitor public land mobile network, wherein the first service is hostable by the target public land mobile network and the home public land mobile network; and routing, based on the determining, from the home public land mobile network to target public land mobile network, signalling for establishing the protocol data unit session at the target public land mobile network; a second apparatus comprising: at least one processor, and at least one memory storing instructions that, when executed by the at least one processor, cause the apparatus to perform: causing, at the target public land mobile network, data associated with the protocol data unit session for the first service to be transferred between the target public land mobile network and a visitor public land mobile network, wherein the user equipment is registered with the visitor public land mobile network.

According to an aspect, there is provided an method comprising: determining, at a home public land mobile network, whether to route signalling for establishing a protocol data unit session for a first service for a user equipment to a target public land mobile network based on at least one of following: a data network name associated with the first service, subscription data associated with the user equipment, or an identity of a visitor public land mobile network serving the user equipment, wherein the user equipment is registered with a visitor public land mobile network, wherein the first service is hostable by the target public land mobile network and the home public land mobile network; routing, based on the determining, from the home public land mobile network to target public land mobile network, signalling for establishing the protocol data unit session at the target public land mobile network; and causing, at the target public land mobile network, data associated with the protocol data unit session for the first service to be transferred between the target public land mobile network and a visitor public land mobile network, wherein the user equipment is registered with the visitor public land mobile network.

According to an aspect, there is provided an apparatus comprising: means for receiving, at a network repository function of a home public land mobile network from a visited public land mobile network, a request for network function discovery that is associated with a first service for a user equipment; means for determining whether to route the request to a target public land mobile network based on at least one of the following: a data network name associated with the first service, or an identity of a visitor public land mobile network serving the user equipment; means for, based on the determining, routing the request from the visited public land mobile network to a network repository function of the target public land mobile network.

According to an aspect, there is provided an apparatus comprising: at least one processor, and at least one memory storing instructions that, when executed by the at least one processor, cause the apparatus to perform: receiving, at a network repository function of a home public land mobile network from a visited public land mobile network, a request for network function discovery that is associated with a first service for a user equipment; determining whether to route the request to a target public land mobile network based on at least one of the following: a data network name associated with the first service, or an identity of a visitor public land mobile network serving the user equipment; based on the determining, routing the request from the visited public land mobile network to a network repository function of the target public land mobile network.

According to an aspect, there is provided a method comprising: receiving, at a network repository function of a home public land mobile network from a visited public land mobile network, a request for network function discovery that is associated with a first service for a user equipment; determining whether to route the request to a target public land mobile network based on at least one of the following: a data network name associated with the first service, or an identity of a visitor public land mobile network serving the user equipment; based on the determining, routing the request from the visited public land mobile network to a network repository function of the target public land mobile network.

In some aspects, the apparatus comprises: means for accessing the data network name associated with the first service, and the identity of a visitor public land mobile network serving the user equipment. In an example, a first identity of a visitor public land mobile network is associated with a first data network name, wherein the first visitor public land mobile network associated with the first data network name is mapped to a first target public land mobile network. In an example, the apparatus comprises means for: determining whether the request is associated the first data network name and is received from the visitor public land mobile network associated with the first identity of the visitor public land mobile network; and based on the determining, routing the request to first target public land mobile network.

According to an aspect, there is provided an apparatus comprises: means for storing, at a unified data management function of a home public land mobile network, session management subscription data for a user equipment comprising at least one of the following: a data network name with an indication of support for routing to a target public land mobile network, or an identity of target public land mobile network; and means for providing, to a session management function of the home public land mobile network, the session management subscription data for the user equipment.

According to an aspect, there is provided an apparatus comprising: at least one processor, and at least one memory storing instructions that, when executed by the at least one processor, cause the apparatus to perform: storing, at a unified data management function of a home public land mobile network, session management subscription data for a user equipment comprising at least one of the following: a data network name with an indication of support for routing to a target public land mobile network, or an identity of target public land mobile network; and providing, to a session management function of the home public land mobile network, the session management subscription data for the user equipment.

According to an aspect, there is provided a method comprising: storing, at a unified data management function of a home public land mobile network, session management subscription data for a user equipment comprising at least one of the following: a data network name with an indication of support for routing to a target public land mobile network, or an identity of target public land mobile network; and providing, to a session management function of the home public land mobile network, the session management subscription data for the user equipment.

According to an aspect, there is provided an apparatus comprises: means for retrieving, at a session management function of a home public land mobile network from a unified data management function of the home public land mobile network, session management subscription data for a user equipment comprising at least one of the following: a data network name with an indication of support for routing to target public land mobile networks, or an identity of target public land mobile network; means for determining a target public land mobile network using at least one of the following: the session management subscription data, or a stored configuration; and

means for invoking a service request towards a session management function of the target public land mobile network based on determination.

According to an aspect, there is provided an apparatus comprising: at least one processor, and at least one memory storing instructions that, when executed by the at least one processor, cause the apparatus to perform: retrieving, at a session management function of a home public land mobile network from a unified data management function of the home public land mobile network, session management subscription data for a user equipment comprising at least one of the following: a data network name with an indication of support for routing to target public land mobile networks, or an identity of target public land mobile network; and determining a target public land mobile network using at least one of the following: the session management subscription data, or a stored configuration; and invoking a service request towards a session management function of the target public land mobile network based on determination.

According to an aspect, there is provided a method comprising: retrieving, at a session management function of a home public land mobile network from a unified data management function of the home public land mobile network, session management subscription data for a user equipment comprising at least one of the following: a data network name with an indication of support for routing to target public land mobile networks, or an identity of target public land mobile network; determining a target public land mobile network using at least one of the following: the session management subscription data, or a stored configuration; and invoking a service request towards a session management function of the target public land mobile network based on determination.

According to an aspect, there is provided an apparatus comprising: means for receiving, at a session management function of a target public land mobile network from session management function of a home public land mobile network, a service request.

According to an aspect, there is provided an apparatus comprising: at least one processor, and at least one memory storing instructions that, when executed by the at least one processor, cause the apparatus to perform: receiving, at a session management function of a target public land mobile network from session management function of a home public land mobile network, a service request.

According to an aspect, there is provided a method comprising: receiving, at a session management function of a target public land mobile network from session management function of a home public land mobile network, a service request.

According to an aspect, there is provided an apparatus comprising: means for controlling, by a session management function of a home public land mobile network, a user plane function of a target public land mobile network by encapsulating N4 messages in a service request message from the session management function of the home public land mobile network to a session management function of the target public land mobile network.

According to an aspect, there is provided an apparatus comprising: at least one processor, and at least one memory storing instructions that, when executed by the at least one processor, cause the apparatus to perform: controlling, by a session management function of a home public land mobile network, a user plane function of a target public land mobile network by encapsulating N4 messages in a service request message from the session management function of the home public land mobile network to a session management function of the target public land mobile network.

According to an aspect, there is provided a method comprising: controlling, by a session management function of a home public land mobile network, a user plane function of a target public land mobile network by encapsulating N4 messages in a service request message from the session management function of the home public land mobile network to a session management function of the target public land mobile network.

According to an aspect, there is provided an apparatus comprising: means for storing, at a unified data management function of a home public land mobile network, session management function subscription selection subscription data, wherein the session management function subscription selection subscription data comprises, per data network name: an indication of whether the data network name supports routing to a target public land mobile network, and an identity of a target public land mobile network; and means for providing, to an access and mobility management function, the session management function subscription selection subscription data.

According to an aspect, there is provided an apparatus comprising: at least one processor, and at least one memory storing instructions that, when executed by the at least one processor, cause the apparatus to perform: storing, at a unified data management function of a home public land mobile network, session management function subscription selection subscription data, wherein the session management function subscription selection subscription data comprises, per data network name: an indication of whether the data network name supports routing to a target public land mobile network, and an identity of a target public land mobile network; and providing, to an access and mobility management function, the session management function subscription selection subscription data.

According to an aspect, there is provided a method comprising: storing, at a unified data management function of a home public land mobile network, session management function subscription selection subscription data, wherein the session management function subscription selection subscription data comprises, per data network name: an indication of whether the data network name supports routing to a target public land mobile network, and an identity of a target public land mobile network; and providing, to an access and mobility management function, the session management function subscription selection subscription data.

According to an aspect, there is provided an apparatus comprising: means for receiving, at an access and mobility management function of a visited public land mobile network, session management function subscription selection subscription data comprises, per data network name: an indication of whether the data network name supports routing to a target public land mobile network, and an identity of a target public land mobile network; and means for, based on the session management function selection subscription data during a protocol data unit session establishment, determining whether the protocol data unit session is to be routed to a target public land mobile network; means for, based on the determining, using the identity of the target public land mobile network to discover a session management function of the target public land mobile network; and means for including an instance identity associated with the session management function of the target public land mobile network and an identity of a target public land mobile network in a request message towards a session management function of the visited public land mobile network.

According to an aspect, there is provided an apparatus comprising: at least one processor, and at least one memory storing instructions that, when executed by the at least one processor, cause the apparatus to perform: receiving, at an access and mobility management function of a visited public land mobile network, session management function subscription selection subscription data comprises, per data network name: an indication of whether the data network name supports routing to a target public land mobile network, and an identity of a target public land mobile network; based on the session management function selection subscription data during a protocol data unit session establishment, determining whether the protocol data unit session is to be routed to a target public land mobile network; based on the determining, using the identity of the target public land mobile network to discover a session management function of the target public land mobile network; and including an instance identity associated with the session management function of the target public land mobile network and an identity of a target public land mobile network in a request message towards a session management function of the visited public land mobile network.

According to an aspect, there is provided an method comprising: receiving, at an access and mobility management function of a visited public land mobile network, session management function subscription selection subscription data comprises, per data network name: an indication of whether the data network name supports routing to a target public land mobile network, and an identity of a target public land mobile network; and based on the session management function selection subscription data during a protocol data unit session establishment, determining whether the protocol data unit session is to be routed to a target public land mobile network; based on the determining, using the identity of the target public land mobile network to discover a session management function of the target public land mobile network; and including an instance identity associated with the session management function of the target public land mobile network and an identity of a target public land mobile network in a request message towards a session management function of the visited public land mobile network.

A computer product stored on a medium may cause an apparatus to perform the methods as described herein.

A non-transitory computer readable medium comprising program instructions, that, when executed by an apparatus, cause the apparatus to perform the methods as described herein.

An electronic device may comprise apparatus as described herein.

In the above, various aspects have been described. It should be appreciated that further aspects may be provided by the combination of any two or more of the various aspects described above.

Various other aspects are also described in the following detailed description and in the claims.

According to some aspects, there is provided the subject matter of the independent claims. Some further aspects are defined in the dependent claims. Example embodiments that do not fall under the scope of the claims, if any, are to be interpreted as examples useful for understanding the subject disclosure.

### List of Abbreviations

AF: Application Function
AMF: Access and Mobility Management Function
AN: Access Network
BS: Base Station
CN: Core Network
DL: Downlink
eNB: eNodeB
gNB: gNodeB
IIoT: Industrial Internet of Things
LTE: Long Term Evolution
NEF: Network Exposure Function
NG-RAN: Next Generation Radio Access Network
NF: Network Function
NR: New Radio
NRF: Network Repository Function
NW: Network
MS: Mobile Station
PCF Policy Control Function
PLMN: Public land mobile network
HPLMN: Home public land mobile network
TPLMN: Target public land mobile network
VPLMN: Visitor public land mobile network
RAN: Radio Access Network
RF: Radio Frequency
RVAS: Roaming value added service
SMF: Session Management Function
UE: User Equipment
UDR: Unified Data Repository
UDM: Unified Data Management
UL: Uplink
UPF: User Plane Function
3GPP: 3^{rd} Generation Partnership Project
5G: 5^{th} Generation
5GC: 5G Core network
5G-AN: 5G Radio Access Network
5GS: 5G System

### BRIEF DESCRIPTION OF THE DRAWINGS

Some example embodiments will now be described, by way of illustrative and non-limiting example only, with reference to the accompanying drawings in which:

FIG. 1 shows a schematic representation of a 5G system;

FIG. 2 shows a schematic representation of a control apparatus;

FIG. 3 shows a schematic representation of a terminal;

FIG. 4 shows a schematic representation of a wireless communication system with a home public land mobile network, a visitor public land mobile network, a target public land mobile network, and a roaming user equipment;

FIG. 5 shows a schematic representation of interfaces between network functions of a visitor public land mobile network, a home public land mobile network, and a target public land mobile network;

FIG. 6 shows an example signalling flow diagram between network functions of a visitor public land mobile network, a home public land mobile network, and a target public land mobile network;

FIG. 7 shows a schematic representation of interfaces between network functions of a visitor public land mobile network, a home public land mobile network, and a target public land mobile network;

FIG. 8 shows an example signalling flow diagram between network functions of a visitor public land mobile network, a home public land mobile network, and a target public land mobile network;

FIG. 9 shows a schematic representation of interfaces between network functions of a visitor public land mobile network, a home public land mobile network, and a target public land mobile network;

FIGS. 10a and 10b show an example signalling diagram between network functions of a visited public land mobile network, a home public land mobile network, and a target public land mobile network;

FIG. 11 shows an example method flow performed by an apparatus;

FIG. 12 shows an example method flow performed by an apparatus;

FIG. 13 shows an example method flow performed by a system;

FIG. 14 shows an example method flow performed by an apparatus;

FIGS. 15a and 15b show example method flows each performed by an apparatus;

FIGS. 16a and 16b show example method flows each performed by an apparatus;

FIGS. 17a and 17b show example method flows each performed by an apparatus;

FIG. 18 shows a schematic representation of a non-volatile memory medium storing instructions which when executed by a processor allow a processor to perform one or more of the steps of the method of FIGS. 11 to 17b.

### DETAILED DESCRIPTION

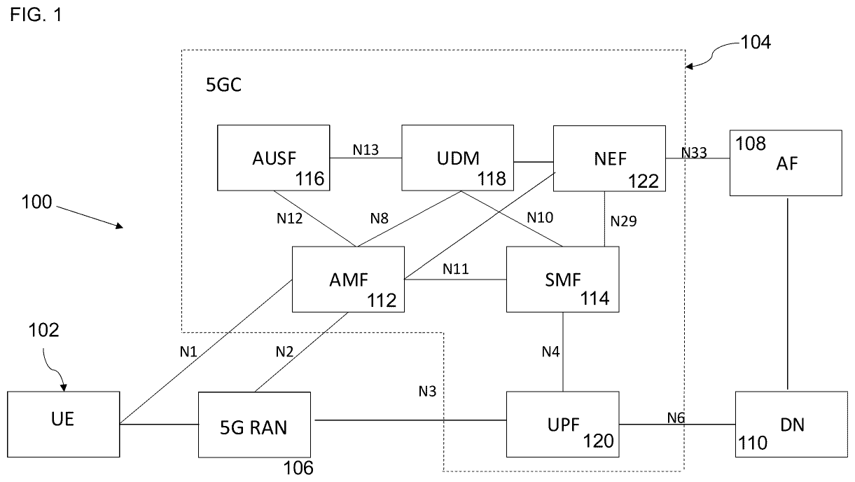

In the following, various example embodiments of the subject disclosure are explained with reference to mobile communication devices capable of communication via a wireless cellular system and mobile communication systems serving such mobile communication devices. Before explaining in detail the various example embodiments, certain general aspects of a wireless communication system and mobile communication devices are briefly explained with reference to FIGS. 1 to 3 to assist in understanding the technology underlying the described examples.

FIG. 1 shows a schematic representation of a wireless communication system 100. The wireless communication system 100 comprises one more devices 102, such as user equipment (UE), or terminals. The wireless communication system 100 also comprises a 5G system (5GS). The 5GS comprises a 5G radio access network (5G-RAN) 106, a 5G core network (5GC) 104 comprising one or more network functions (NF), one or more application functions (AFs) 108, and one or more data networks (DNS) 110.

The 5G-RAN 106 may comprise one or more gNodeB (gNB) distributed unit (DU) functions connected to one or more gNodeB (gNB) centralized unit (CU) functions.

The 5GC 104 comprises an access management function (AMF) 112, a session management function (SMF) 114, an authentication server function (AUSF) 116, a user data management (UDM) 118, a user plane function (UPF) 120, a network exposure function (NEF) 122 and/or other NFs. Some of the example embodiments as described below may be applicable to 3GPP 5G standards. Additionally or alternatively, some example embodiments may be applicable to 3G, 4G, 5G-advanced, 6G and other 3GPP standards or non-3GPP standards.

In a wireless communication system 100, such as that shown in FIG. 1, mobile communication devices/terminals or user apparatus, and/or user equipment (UE), and/or machine-type communication devices are provided with wireless access via at least one base station or similar wireless transmitting and/or receiving node or point. The terminal is provided with an appropriate signal receiving and transmitting apparatus for enabling communications, for example enabling access to a communication network or communications directly with other devices. The communication device may access a carrier provided by a base station or access point, and transmit and/or receive communications on the carrier.

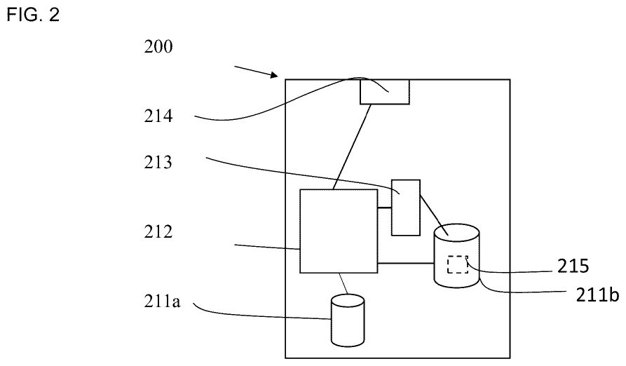

FIG. 2 illustrates an example of a control apparatus 200. The control apparatus 200 may be configured to control a function of one or more network entities/network functions, such as the entities of the 5G-RAN or the 5GC as illustrated on FIG. 1. The control apparatus 200 comprises at least one random access memory (RAM) 211a, at least one read only memory (ROM) 211b, at least one processor 212, 213 and an input/output interface 214. The at least one processor 212, 213 is coupled to the RAM 211a and the ROM 211b. The at least one processor 212, 213 may be configured to execute an appropriate software code 215. The software code 215 may, for example, allow to perform of the various example embodiments of the subject disclosure. The software code 215 may be stored in the ROM 211b. The control apparatus 200 may be interconnected with another control apparatus 200 controlling another entity/function of the 5G-AN or the 5GC. In some example embodiments, each function of the 5G-AN or the 5GC comprises a control apparatus 200. In alternative example embodiments, two or more functions of the 5G-AN or the 5GC may share a control apparatus. The control apparatus 200 may comprise one or more circuits, or circuitry (not shown) which may be configured to perform one or more of the example embodiments.

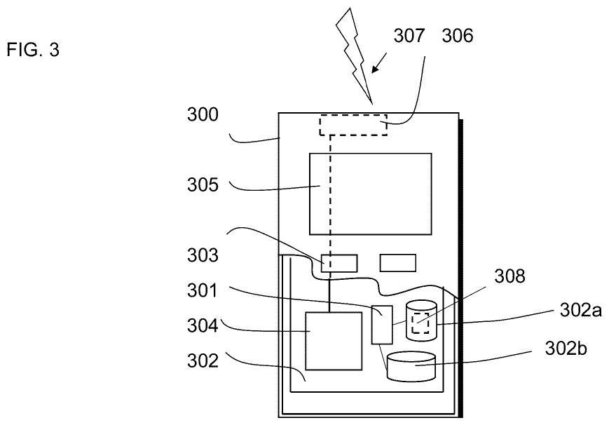

FIG. 3 illustrates an example of a terminal 300, such as the terminal illustrated in FIG. 1. The terminal 300 may be provided by any device capable of sending and receiving radio signals. Illustrative and non-limiting examples of a terminal include a user equipment, a mobile station (MS) or mobile device, such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided, for example, by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may, for example, allow to perform one or more of the various example embodiments of the subject disclosure. The software code 308 may be stored in the ROM 302a. The terminal 300 may comprise one or more circuits, or circuitry (not shown) which may be configured to perform one or more of the various example embodiments of the subject disclosure.

The processor, storage and other relevant control apparatus may be provided on an appropriate circuit board and/or in chipsets. This feature is denoted by reference 304. The device may optionally have a user interface, such as keypad 305, touch sensitive screen or pad, combinations thereof or the like. Optionally one or more of a display, a speaker and a microphone may be provided depending on the type of the device.

In wireless communications, a public land mobile network (PLMN) is a combination of wireless communication services offered by a specific operator (e.g. mobile network operator (MNO)) in a specific country. A PLMN typically comprises several cellular technologies (e.g., 5G/NR, LTE/4G, etc.) offered by a single operator within a given country, often referred to as a cellular network. A PLMN may be identified by a globally unique PLMN code, which may include a MCC (Mobile Country Code) and MNC (Mobile Network Code).

Information associated with a subscriber or a user equipment (e.g. international mobile subscriber identifier (IMSI)) may be used to determine a home PLMN (HPLMN). A subscriber/UE has an HPLMN, where the subscriber profile is configured. While roaming, a subscriber/UE changes its location which may change its roaming PLMN. The new PLMN may be the same as HPLMN or its other network's PLMN. When roaming, a subscriber attaches to a core network via an access network. The roaming core network belongs to a PLMN. This is called a visiting or visitor VPLMN (VPLMN). The VPLMN and HPLMN may be the same or different, depending upon the location of the subscriber/UE and the serving MNO.

3GPP is working on potential requirements for supporting roaming value-added services (RVAS) in future studies (e.g. in 3GPP TR 22.877). An RVAS provider may be an external entity, acting outside the perimeter of an MNO's network domain, providing RVAS services to an MNO. The services provided may include services that serve the subscriber (e.g. roaming control service, roaming welcome message), or those that serve the network (e.g. to solve interoperability issues, corrective actions).

It has been identified that there may be problems when a subscriber/UE is roaming from a home country to a roaming country. For example, there may be a multi-national operator (e.g. MNO 1). MNO 1 may have two or more PLMN IDs. For example, ‘MNO 1 India’ and ‘MNO 1 Sri Lanka’. A UE of MNO 1 India may be roaming in Sri Lanka (i.e. MNO 1 India is the HPLMN for the UE). The UE may register to any of the VPLMNs in Sri Lanka. For example, the UE has subscribed for ‘service X’, which is hosted by MNO 1. The service X is hosted by both ‘MNO 1 India’ and ‘MNO 1 Sri Lanka’. When the UE is roaming in Sri Lanka and registered to a VPLMN, if the UE wants to access service X, the UE will establish a home routing (HR) protocol data unit (PDU) session to its home network i.e. MNO 1 India. However, the established HR PDU session between Sri Lanka and India means that communications for the PDU session have to travel back and forth to India, where the HPLMN is situated. This can have a negative effect on user experience for the UE due to increased latency. Furthermore, traffic routing between countries leads to a higher changes of service failures.

One or more of the various example embodiments described herein aim to address one or more of the problems identified above.

In some example embodiments, there is provided an apparatus that is configured for receiving, at a target public land mobile network, signalling for establishing a protocol data unit session for a first service for a user equipment, wherein the first service is hostable by the target public land mobile network and a home public land mobile network. The apparatus also configured for causing data associated with the protocol data unit session for the first service to be transferred between the target public land mobile network and a visitor public land mobile network, wherein the user equipment is registered with the visitor public land mobile network. Further aspects of this and other example embodiments will be described in more detail below.

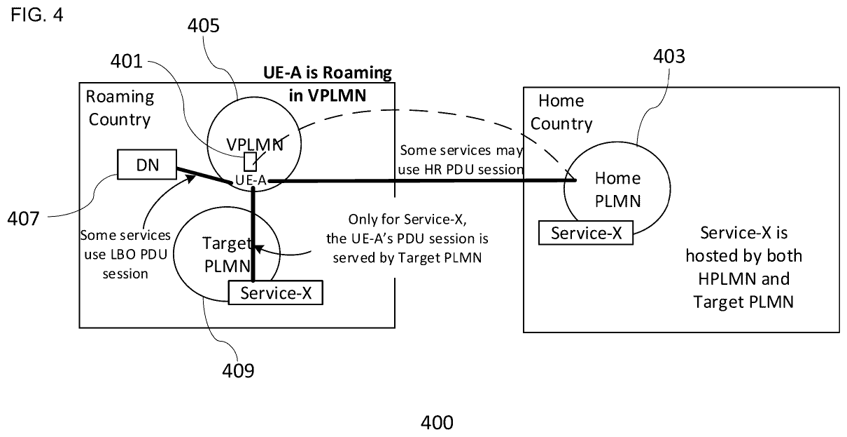

FIG. 4 shows a schematic representation of a wireless communication system with a home public land mobile network, a visitor public land mobile network, a target public land mobile network, and a roaming user equipment.

In the system 400 of FIG. 4, there is provided a ‘home’ country (e.g., India) for a UE 401 (UE-A). There is also provided a ‘roaming’ country (e.g., Sri Lanka). The home country has a HPLMN 403, and the roaming country has a VPLMN 405. UE-A 401 is roaming in VPLMN 405. From the example problem discussed above, MNO 1 India may be associated with the HPLMN 403 and MNO 1 Sri Lanka may be associated with the VPLMN 405.

Some services may be provided to UE-A 401 with a home routing (HR) PDU session between the VPLMN 405 and the HPLMN 403. As discussed above, this may lead to high latencies for the session.

There is provided a data network (DN) 407 in the roaming country. UE-A 401 may be able to access some services using a local breakout (LBO) PDU session to the DN 407. With a LBO PDU session, the session will be managed by the VPLMN 403.

In FIG. 4, MNO 1 Sri Lanka and MNO 1 India are, for example, both able to host ‘service X’. There is provided a target PLMN (TPLMN) 409. TPLMN 409 is able to host ‘service X’. The TPLMN 409 is configured to establish a PDU session for ‘service X’ for the UE-A 401, wherein the ‘service X’ is hostable by the TPLMN 409 and the HPLMN 403. Following the establishment of the PDU session, the TPLMN 409 is able to transmit and receive data associated with the PDU session for service X between the TPLMN 409 and the VPLMN 405. That is, downlink data for the PDU session is provided from the TPLMN 409 to the VPLMN 405, and uplink data for the PDU session is provided from the VPLMN 405 to the TPLMN 409.

It can be beneficial for the user experience (e.g. latency, throughput, etc) that the specific service (e.g., ‘service X’) is provided by T-PLMN 409 of MNO 1 Sri Lanka instead of MNO 1 India when the UE is roaming in Sri Lanka. Traffic routing within a country makes a service less failure prone, as the traffic does need to cross a country boundary (e.g. between India and Sri Lanka). In this manner, a mechanism is provided in which the PDU session specific to Service-X is served by the target PLMN 409 (i.e. MNO 1 Sri Lanka) while the PDU sessions for other services still use either Home Routed (to MNO 1 India) or LBO. Some services (e.g. service X) of one subscriber (e.g. UE-A 401) or a group of subscribers are handled by the target PLMN 409 instead of the HPLMN 403, where the determination of which entity/network should serve the service is based on a UE's subscription data and a current serving PLMN.

Further aspects of this and some other example embodiments will be described in more detail below.

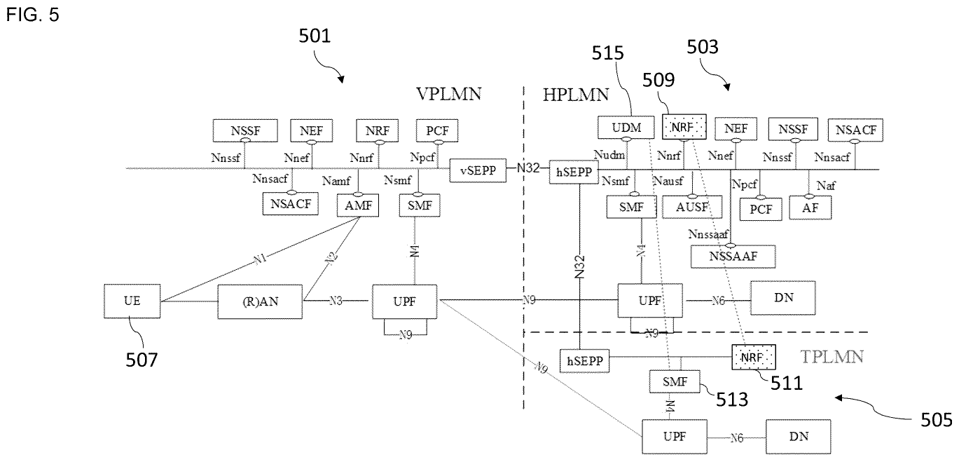

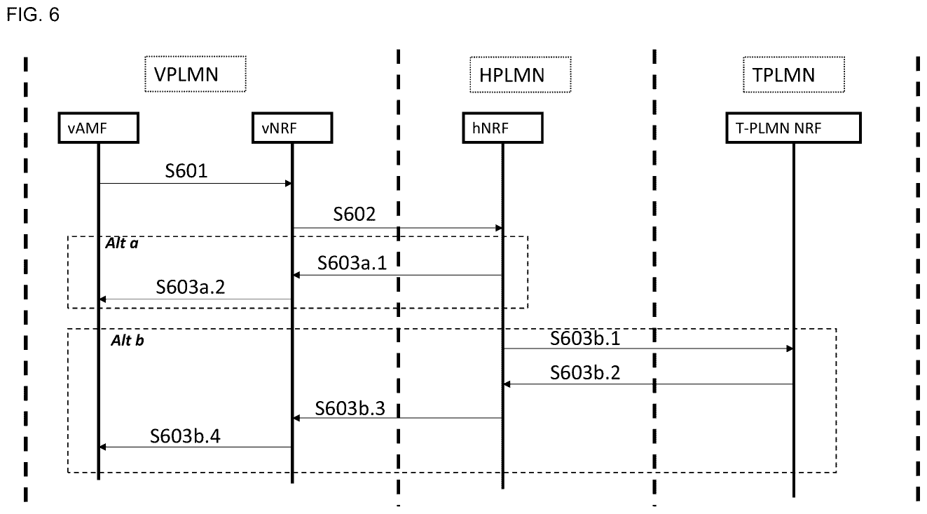

In some example embodiments, an NRF of a HPLMN (H-NRF) is configured to forward an H-SMF (SMF of the HPLMN) discovery request from a VPLMN to a TPLMN based on a data network name (DNN) and an identity of the VPLMN (VPLMN ID). The DNN and/or the VPLMN ID may be configured locally, in the NRF of the HPLMN. For example, a VPLMN NRF sends a discovery request to a HPLMN NRF to discover a H-SMF. The HPLMN NRF has a stored configuration/access to a configuration that when an SMF discovery request is received from a VPLMN with a specific VPLMN ID (e.g. VPLMN ID “X), for a specific DNN (e.g. DNN “Y”), then the request is forwarded to a TPLMN. The TPLMN is determined based on the VPLMN ID. The TPLMN then provides information about an SMF of the TPLMN (T-SMF) to the VPLMN, which establishes the PDU Session for the (requested) DNN. The TPLMN then selects a UPF of the TPLMN (T-UPF) to serve a PDU Session. Following the establishment of the PDU session, uplink and downlink data is transferred between the VPLMN and the TPLMN. In this example embodiment, the HPLMN is not involved with data transfer (uplink and downlink) for the PDU session. Further aspects of this and some other example embodiments will be described in more detail below alongside FIGS. 5 and 6.

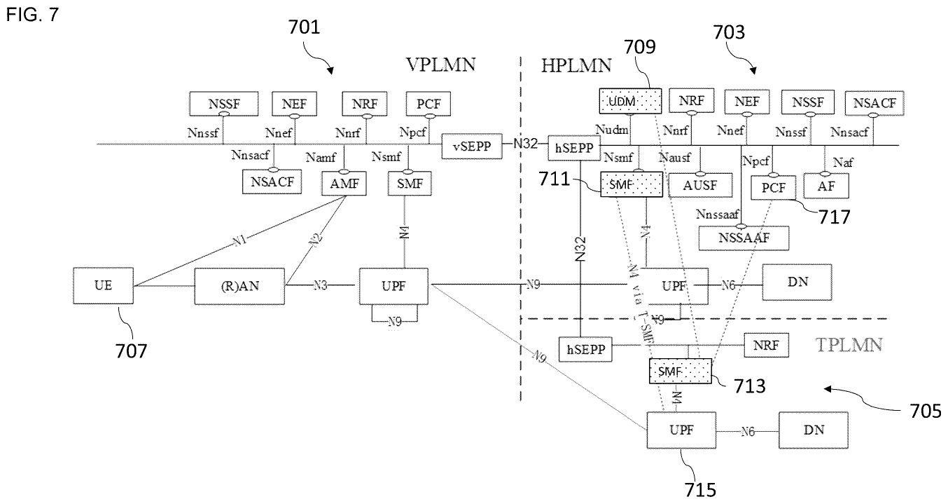

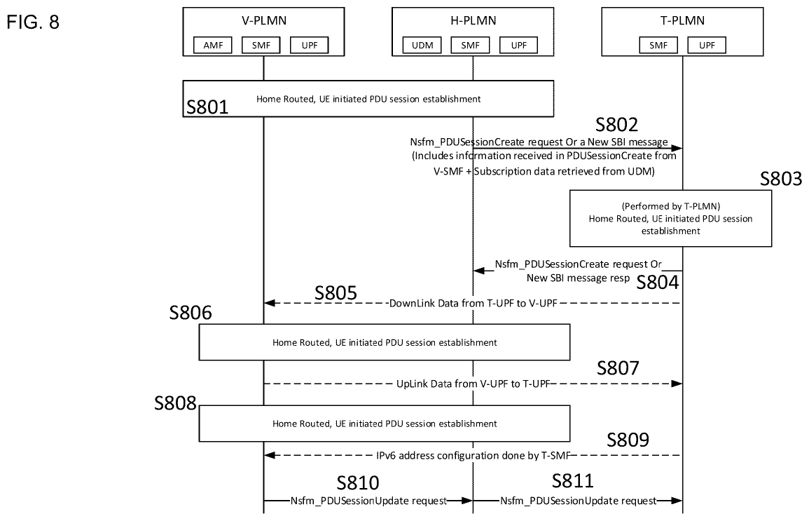

In some example embodiments, an SMF of a HPLMN SMF (H-SMF) is configured to invoke a service towards an SMF of a TPLMN (T-SMF) when the H-SMF receives a PDU session establishment request for a UE from an SMF of a VPLMN (V-SMF), where a DNN is enabled for routing to the TPLMN for that VPLMN. The session establishment request includes PDU session information provided by the VPLMN, and subscription data for the UE retrieved from a UDM. The UDM is associated with the HPLMN. In an alternative example embodiment, the T-SMF downloads the subscription data from the UDM. The T-SMF processes the session establishment request and selects a UPF of the TPLMN (T-UPF) to serve a PDU session and provides a response back to the H-SMF. In response to receiving the response from the T-SMF, the H-SMF provides a response to the V-SMF. The signalling exchanged for managing the PDU session that has been established between the VPLMN and the TPLMN happens via the HPLMN. Following the establishment of the PDU session, uplink and downlink data is transferred between the VPLMN and the TPLMN. In this example embodiment, the HPLMN is not involved with data transfer (uplink and downlink) for the PDU session. Further aspects of this and some other example embodiments will be described in more detail alongside FIGS. 7 and 8.

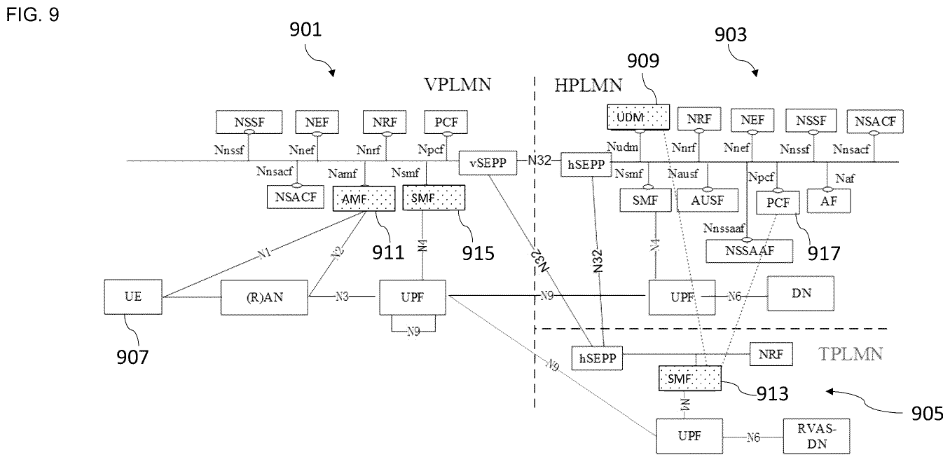

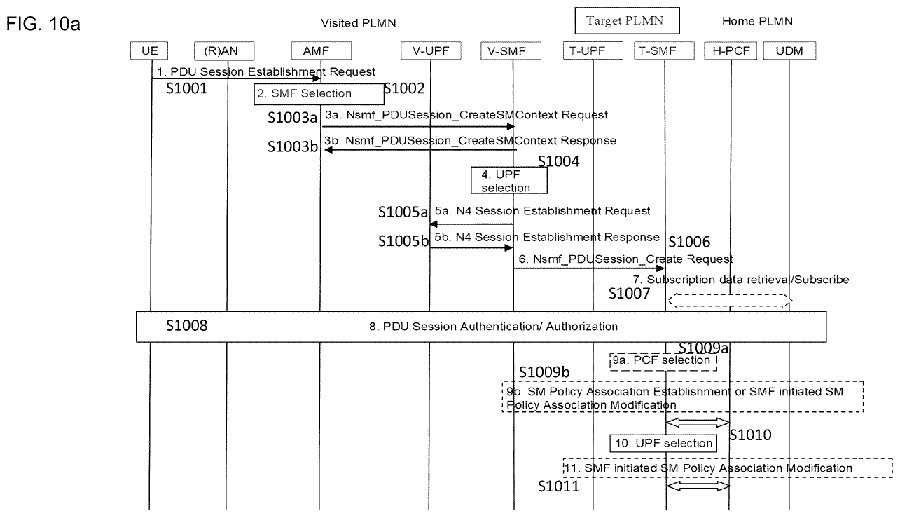

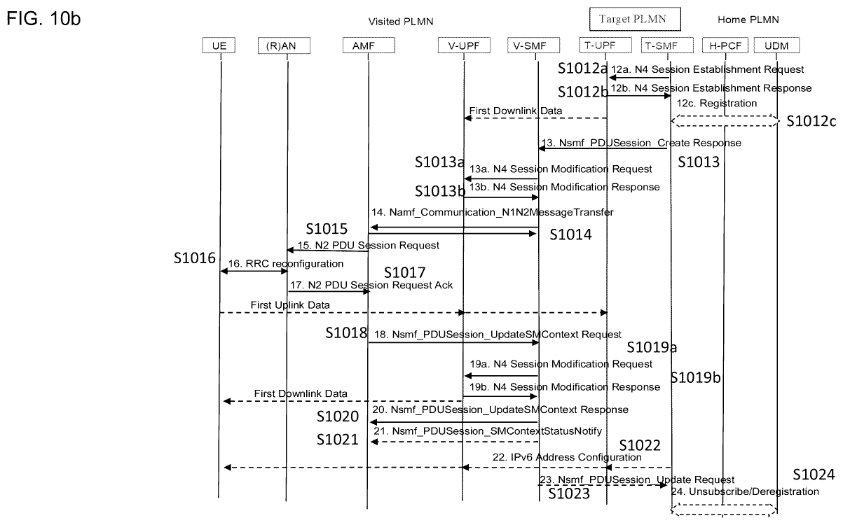

In some example embodiments, subscription data associated with a UE (which may be used for SMF selection), is provided per VPLMN and stored in a UDM, where the subscription data comprises at least one of the following indications, per DNN: i) whether the DNN is enabled for routing to a TPLMN, ii) a TPLMN ID. In a UDM, different UE subscription data may be stored. For example, at least one of the following: Access and Mobility subscription data, Session Management Subscription data, or SMF selection subscription data. The indications, per DNN may be stored in/comprised in the SMF selection subscription data, in some example embodiments. During a PDU session establishment, based on the subscription data, an AMF of a VPLMN (V-AMF) determines that the PDU session will be routed to a TPLMN. The V-AMF uses a TPLMN ID associated with the TPLMN to discover a T-SMF. The discovered T-SMF will act as an H-SMF for the (home routed) PDU session. The V-AMF includes the T-SMF, and TPLMN ID in a Nsmf_PDUSession_CreateSMContext request towards a V-SMF. The V-SMF sends the Nsmf_PDUSession_CreateSMContext to the selected T-SMF. In some example embodiments, this may be followed by further steps, such as the procedure as specified in clause 4.3.2.2.2 of 3GPP TS 23.502. Once the HR PDU session is established, H-SMF and H-UPF are replaced by the T-SMF and T-UPF (e.g. the PDU session is established between the TPLMN and VPLMN). Further aspects of this and some other example embodiments will be described in more detail alongside FIGS. 9, 10a and 10b.

FIG. 5 shows a schematic representation of interfaces between network functions of a visitor public land mobile network, a home public land mobile network, and a target public land mobile network.

FIG. 5 shows similar network functions to those described in FIG. 1 above, where network functions are associated with each of a VPLMN 501, a HPLMN 503, and a TPLMN 505. In the example embodiments of FIG. 5, a UE 507 is roaming and is registered with the VPLMN 501.

As shown in FIG. 5, an NRF of the HPLMN (H-NRF) 509 is configured to select an NRF of the TPLMN (T-NRF) 511 and send the discovery request query to the T-NRF. In this manner, the H-NRF 509 interfaces with the T-NRF 511. In some example embodiments, the H-NRF 509 selects the T-NRF 511 based on a DNN and a serving PLMN ID. An SMF of the TPLMN (T-SMF) 513 is able to retrieve subscription data from a UDM of the HPLMN (UDM) 515.

In some example embodiments, there are provided enhancements for SMF selection by an AMF during a HR PDU session. A UE-requested PDU session establishment for home-routed roaming scenarios (e.g., in relation to the procedure of clause 4.3.2.2.2 of TS 23.502) may be performed.

For an SMF selection, an AMF selects an SMF in a HPLMN using single network slice association information (S-NSSAI) of the HPLMN used for a PDU session. In some example embodiments, this is performed in addition to the steps performed at step 2 described in clause 4.3.2.2.3 of TS 23.502.

In some example embodiments, there are provided enhancements for HPLMN SMF selection (e.g., in relation to clause 4.3.2.2.3 of TS 23.502).

When an NRF of the HPLMN (hNRF) receives a Nnrf_NFDiscovery_Request, the hNRF, based on a DNN and a serving PLMN ID, determines that the received query should be forwarded to a T-NRF. The hNRF triggers an “NF Discovery” on behalf of a V-AMF to the T-NRF. The hNRF uses a local configuration for mapping between a serving PLMN and the DNN to the Target PLMN. Then, the T-NRF provides information about a set of the T-SMF instance(s) in a Nnrf_NFDiscovery_Request response message to the hNRF. In some example embodiments, these steps are performed at step 6 of 4.3.2.2.3.3-1 or at step 2 of 4.3.2.2.3.3-2 in TS 23.502. Following this, the SMF selection is completed, where H-SMF is replaced by the T-SMF and the H-UPF is replaced by a T-UPF for the PDU session. In this manner, the T-SMF takes on the role of H-SMF, and the T-UPF takes on the role of H-UPF.

In some example embodiments, before sending a Nsmf_PDUSession_Create Request, when the V-SMF sends a T-SMF discovery request to the vNRF (and hNRF) based on a T-SMF instance ID received from V-AMF, the hNRF uses the same local configuration (e.g. based on DNN and the serving PLMN ID,) to determine that the query is to be forwarded to a T-NRF to retrieve an NF Profile of the T-SMF matching the NF instance ID.

The PCF and UDM remain at the Home PLMN, which means that the T-SMF may fetch session management (SM) subscription data from H-UDM. The T-SMF may also register with the H-UDM. For SM policies, the T-SMF interacts with a H-PCF.

FIG. 6 shows an example signalling flow diagram between network functions of a visitor public land mobile network, a home public land mobile network, and a target public land mobile network.

FIG. 6 shows a discovery for an NRF for a TPLMN. When a DNN and a VPLMN ID is not configured for RVAS routing, then S603a is followed, as described below (e.g. existing behaviour). When the DNN and the VPLMN ID is configured for RVAS routing, then S603b is followed, as described below.

In the example embodiments of FIG. 6, it is assumed that a UE is roaming and is registered with a VPLMN.

At S601, an AMF of a VPLMN (vAMF) provides a NF discovery request to an NRF of the VPLMN (vNRF). The NF discovery request may be an Nnrf_NFDiscovery_Request message in some example embodiments. In other example embodiments, other suitable messages are used.

At S602, the vNRF forwards the request to an NRF of a HPLMN (hNRF).

In a first alternative (alt a), when a DNN and a VPLMN ID is not configured for RVAS routing, then S603a can be set to occur.

At S603a.1, the hNRF provides a response message to the vNRF. The response message may be a Nnrf_NFDiscovery_Request response. In other example, embodiments other suitable messages are used.

At S603a.2, the vNRF forwards the response message to vAMF.

In a second alternative (alt b), when the DNN and the VPLMN ID is configured for RVAS routing, then S603b can be set to occur.

At S603b.1, the hNRF forwards the request message to an NRF of a TPLMN (TPLMN NRF).

The hNRF may forward the NF discovery request based on a VPLMN ID of the VPLMN that provided the request, and a DNN associated with the request. For example, the VPLMN NRF has sent a discovery request to the HPLMN NRF to discover a H-SMF (e.g. S602). The hNRF has a stored configuration of one or more VPLMN IDs with DNNs. The VPLMN IDs may be referred to as serving PLMN IDs in some example embodiments. When the SMF discovery request is received from the V-NRF with a specific VPLMN ID (e.g. VPLMN ID “X), for a specific DNN (e.g. DNN “Y”), then the request is forwarded to the T-NRF. The TPLMN may be determined based on the VPLMN ID.

At S603b.2, the TPLMN NRF provides a response message to the hNRF. The response message may be a Nnrf_NFDiscovery_Request response. In other example embodiments, other suitable messages are used.

At S603b.3, the hNRF forwards the response message to the vNRF.

At S603b.4, the vNRF forwards the response message to vAMF.

An outcome of the signalling for ‘alt b’ is that an NRF of the TPLMN is discovered and selected for a PDU session. In FIG. 6, the hNRF may, based on a DNN and the serving PLMN ID, determine that the request (query) should be forwarded to the TPLMN NRF. The hNRF triggers an “NF Discovery” on behalf of the V-AMF to the TPLMN NRF. The hNRF uses a local configuration for mapping between a serving PLMN and DNN to the TPLMN. Then, the TPLMN NRF provides information about a set of the T-SMF instance(s) in the Nnrf_NFDiscovery_Request response message to the hNRF.

FIG. 7 shows a schematic representation of interfaces between network functions of a visitor public land mobile network, a home public land mobile network, and a target public land mobile network.

FIG. 7 shows similar network functions to those described in FIG. 1 above, where network functions are associated with each of a VPLMN 701, a HPLMN 703, and a TPLMN 705. In the example embodiments of FIG. 7, a UE 707 is roaming and is registered with the VPLMN 701.

There is provided a UDM 709 of the HPLMN 703. Session management subscription data of a UE stored in the UDM 709 is configured to comprise at least one of the following: DNN marked/indicated for RVAS routing, or a target PLMN ID for RVAS routing.

There is provided an SMF of the HPLMN 703 (H-SMF) 711. The H-SMF 711 provides/invokes a service request towards an SMF of the TPLMN 705 (T-SMF) 713, based on the target PLMN ID for RVAS routing received in session management subscription data from the UDM 709. In other example embodiments, instead of a service request, the H-SMF 711 provided a Nsfm_PDUSessionCreate message including SM subscription data retrieved by the H-SMF from the UDM. Alternatively or additionally, the H-SMF 711 may control a UPF of the TPLMN 705 (T-UPF) 715 via the T-SMF 713, encapsulating N4 messages in a ‘new’ service based interface (SBI) message from the H-SMF 711 to the T-SMF 713.

In some example embodiments, the T-SMF 713 receives the service request (or the Nsfm_PDUSessionCreate) from the H-SMF 711 and is responsible for managing a PDU session for the UE 707. The T-SMF 713 registers to the UDM 709 and establishes a policy association with a PCF of the HPLMN 703 (H-PCF) 717.

In some example embodiments, the T-SMF translates N4 messages encapsulated in the ‘new’ SBI message into an N4 request towards the T-UPF. In the 5G Core (5GC) network, the N4 interface is the bridge between the control plane and the user plane. In this example embodiment, the H-SMF 711 is managing the PDU session and also controlling the T-UPF. In this manner, the H-SMF 711 registers to the UDM 709 and establishes policy association with the H-PCF 717.

FIG. 8 shows an example signalling flow diagram between network functions of a visitor public land mobile network, a home public land mobile network, and a target public land mobile network.

There is provided a V-PLMN, which has a V-AMF, V-SMF and a V-UPF. There is also provided a H-PLMN, which has a UDM, an H-SMF and an H-UPF. There is also provided a T-PLMN, which has a T-SMF and a T-UPF.

In the example signalling diagram of FIG. 8 it is assumed that a UE is roaming and is registered at the VPLMN.

At S801, the UE initiates a PDU session establishment. As the UE is roaming, the PDU session may be a home routed PDU session. As part of the establishment of the PDU session, there is signalling between NFs of the VPLMN and the HPLMN. The HPLMN is the home PLMN of the UE.

The UE may, for example, be requesting the initiation of a PDU session for a specific service (e.g., also referred to ‘the first service’ herein). In this example embodiment, it may be assumed that the first service may be hosted, or provided, by both the TPLMN and the HPLMN. Based on the serving PLMN that the UE is registered to, the HPLMN determines whether to route the signalling to the TPLMN.

During the establishment, when the H-SMF retrieves session management subscription data of the UE from the UDM (of the HPLMN), the H-SMF determines that the PDU session shall be handled at TPLMN. The determination to route the signalling to the TPLMN may be controlled at the HPLMN based on at least one of the following: subscription data of the UE, information related to the DNN that the UE is trying to access, or a VPLMN ID that is currently serving the UE.

In some example embodiments, steps 1 through 9 of clause 4.3.2.2.2 of TS 23.502 (e.g., an HR UE initiated PDU session establishment) may be performed at S801.

At S802, the H-SMF provides/invokes a service request message towards the T-SMF. The service request may be an SBI message. In other example embodiments, the H-SMF provides a Nsfm_PDUSessionCreate message to the T-SMF (rather than the service request). The message to the T-SMF comprises information received from the V-SMF in Nsmf_PDUSessionCreate request and session management subscription data retrieved from the UDM by the H-SMF. In other example embodiments, rather than being provided in the message, the T-SMF retrieves the SM subscription data from the UDM.

At S803, based on the message received at the T-SMF, the TPLMN initiates an establishment of a PDU session for the UE. The establishment of the PDU session is such that it is to be established at the TPLMN.

In some example embodiments, the T-SMF selects a T-UPF of the TPLMN for the PDU session.

In some example embodiments, steps 10 through 12c of clause 4.3.2.2.2 of TS 23.502 (e.g., an HR UE initiated PDU session establishment) may be performed at S803, wherein steps 10 through 12c are performed by the TPLMN.

At S804, the T-SMF provides a response message to the H-SMF. The response message may be a service request response in some example embodiments. The response message may be a Nsfm_PDUSessionCreate response message in some example embodiments.

At S805, downlink (DL) data for the PDU session is provided from the TPLMN to the VPLMN. For example, the DL data is provided from a T-UPF of the TPLMN to a V-UPF of the VPLMN.

At S806, there may be further signalling between the VPLMN and the HPLMN for the PDU session.

In some example embodiments, steps 13 through 17 of clause 4.3.2.2.2 of TS 23.502 (e.g., an HR UE initiated PDU session establishment) may be performed at S806.

At S807, uplink (UL) data for the PDU session is provided from the VPLMN to the TPLMN. For example, the UL data is provided from the V-UPF to the T-UPF.

At S808, there may be further signalling between the VPLMN and the HPLMN for the PDU session.

In some example embodiments, steps 18 through 21 of clause 4.3.2.2.2 of TS 23.502 (e.g., an HR UE initiated PDU session establishment) may be performed at S808.

At S809, an IPV6 address configuration is provided from the TPLMN to the VPLMN.

At S810, when an update for the established PDU session is to be provided, the VPLMN provides an update request message to the HPLMN. The update request message may be a Nsfm_PDUSessionUpdate request message.

At S811, the HPLMN forwards the update request message to the TPLMN.

In some example embodiments, the H-SMF establishes an N4 session with the T-UPF via T-SMF. The service request/SBI message (e.g., provided from the HPLMN to the TPLMN) may comprise an N4 message container from the H-SMF to the T-SMF. The T-SMF then sends that N4 message over an N4 interface towards the T-UPF. In this manner, N4 messages sent from the T-UPF to the T-SMF are then carried over an SBI message to the H-SMF. The H-SMF is then in control of, for example, internet protocol (IP) allocation, event exposure, quality of service (QOS) control, charging, etc. In this example embodiment, the T-UPF selection is performed by the H-SMF (e.g., instead of the T-SMF).

In this example embodiment, subscription data for the UE is not sent from HPLMN to TPLMN.

FIG. 9 shows a schematic representation of interfaces between network functions of a visitor public land mobile network, a home public land mobile network, and a target public land mobile network.

FIG. 9 shows similar network functions to those described in FIG. 1 above, where network functions are associated with each of a VPLMN 901, a HPLMN 903, and a TPLMN 905. In the example embodiments of FIG. 9, a UE 907 is roaming and is registered with the VPLMN 901.

There is provided a UDM 909 of the HPLMN 903. SMF selection subscription data may be comprised in the UDM 909. The SMF selection subscription data may comprise at least one of the following, per DNN: whether the DNN is enabled for the RVAS feature (e.g. routing to a TPLMN), or a TPLMN ID. The indication of whether the DNN is enabled for the RVAS feature may, for example, be implemented as a flag, an indication message, etc.

There is provided an AMF 911 of the VPLMN 901. Based on SMF selection subscription data during a PDU Session establishment, the V-AMF 911 determines that the PDU session should be routed to the TPLMN 905 (e.g., rather than the H-PLMN 903). The V-AMF 911 uses a TPLMN ID to discover a T-SMF 913 (e.g., that will act as the H-SMF for the HR PDU session).

The V-AMF 911 includes a T-SMF NF instance ID, and the T-PLMN ID in a Nsmf_PDUSession_CreateSMContext Request towards a V-SMF 915.

The V-SMF 915 uses TPLMN SMF 913 information and TPLMN ID information to discover the T-SMF 913 for PDU session establishment. The T-SMF 913 retrieves SM subscription data from the UDM 909 and registers with the UDM 913. For SM policies, the T-SMF 913 interacts with a PCF 917 of the HPLMN.

FIGS. 10a and 10b show an example signalling diagram between network functions of a visited public land mobile network, a home public land mobile network, and a target public land mobile network.

For the signalling of FIGS. 10a and 10b, it is assumed that a UE is roaming is a registered with the VPLMN.

FIG. 10a shows S1001 to S1011. FIG. 10b shows S1012a to S1024.

At S1001, the UE provides a PDU session establishment request to an AMF of the VPLMN.

At S1002, the AMF performs an SMF selection.

Based on SMF selection subscription data retrieved/received during the PDU session establishment, the AMF determines that the PDU Session should be routed to the TPLMN instead of H-PLMN, in some example embodiments. The AMF uses a Target PLMN ID to discover the T-SMF (that will act as the H-SMF for the HR PDU session).

At S1003a, the AMF provides a Nsfm_PDUSession_CreateSMContext request to a V-SMF. The AMF may includes T-SMF information (e.g. T-SMF NF instance ID), and a T-PLMN ID in the Nsmf_PDUSession_CreateSMContext Request towards the V-SMF.

At S1003b, the V-SMF provides a Nsfm_PDUSession_CreateSMContext response to the AMF.

At S1004, the V-SMF performs a UPF selection. The V-SMF uses the T-SMF information and/or TPLMN ID information to discover the T-SMF for the PDU session establishment.

At S1005a, the V-SMF provides an N4 session establishment request to a V-UPF.

At S1005b, the V-UPF provides an N4 session establishment response to the V-SMF.

At S1006, the V-SMF provides a Nsfm_PDUSession_Create request to a T-SMF.

At S1007, the T-SMF and a UDM interact such that the T-SMF retrieves subscription data for the UE. For example, the T-SMF retrieves SM subscription data from the UDM.

SMF selection subscription data may be comprised in the UDM. The SMF selection subscription data may comprise at least one of the following, per DNN: whether the DNN is enabled for the RVAS feature (e.g. routing to a TPLMN), or a TPLMN ID. The T-SMF may retrieve the SMF selection subscription data.

At S1008, there is a PDU session authentication/authorisation.

At S1009a the T-SMF performs a PCF selection.

At S1009b, the T-SMF and (selected) H-PCF perform an SM policy association establishment or SMF initiated SM policy association modification.

At S1010, the T-SMF performs a UPF selection.

At S1011, the T-SMF and H-PCF interact for an SMF initiated SM policy association modification.

At S1012a, the T-SMF provides an N4 session establishment request to the selected T-UPF.

At S1012b, the T-UPF provides an N4 session establishment response message to the T-SMF.

At S1012c, the T-SMF registers with the UDM.

At this stage, downlink data is provided from the T-UPF to the V-UPF, for the PDU session.

At S1013, the T-SMF provides a Nsmf_PDUSession_Create response message to the V-SMF.

At S1013a, the V-SMF provides an N4 session medication request to the V-UPF.

At S1013b, the V-UPF provides an N4 session modification response message to the V-SMF.

At S1014, there is an Namf_Communication_N1N2Message transfer between the AMF and the V-SMF.

At S1015, the AMF provides an M2 PDU session request to a RAN.

At S1016, the RAN and the UE interact for an RRC reconfiguration.

At S1017, the RAN provides an N2 PDU session request acknowledgement message to the AMF.

At this stage, uplink data is provided from the UE, to the V-UPF, onto the T-UPF.

At S1018, the AMF provides an Nsmf_PDUSession_UpdateSMContext request message to the V-SMF.

At S1019a, the V-SMF provides an N4 session modification request to the V-UPF.

At S1019b, the V-UPF provides an N4 session modification response to the V-SMF.

At this stage, the downlink data is provided from the V-UPF to the UE.

At S1020, the V-SMF provides an Nsmf_PDUSession_UpdateSMcontext response to the AMF.

At S1021, the V-SMF provides an Nsmf_PDUSession_SMContextStatusNotify message to the AMF.

At S1022, there is an IPV6 address configuration from the T-SMF to the UE, via the T-UPF and the V-UPF.

At S1023, the V-SMF provides an Nsmf_PDUSession_Update request to the T-SMF.

At S1024, the T-SMF and UDM interact for a unsubscribe/deregistration action.

It should be understood that the example signalling discussed alongside FIGS. 5 to 10 may be performed in combination with each other. When examples of signalling from FIGS. 5 to 10 is combined, the signalling may be performed in different orders and/or one or more signalling steps may be performed in different orders. Furthermore, one or more other intermediate signalling steps may be included between any of the signalling steps described herein.

One or more of the various example embodiments described herein include enhancements apparent to those skilled in the relevant arts. By way of illustrative and non-limiting example, one or more of the various example embodiments provide a roaming user equipment the ability to benefit from an improved user experience due to reduced latency and increased throughput, as specific services while roaming are provided from a TPLMN within the country that the user equipment is roaming in. As the specific service is hosted by a TPLMN within the roaming country, rather than being routed to the home country (home roaming), uplink and downlink data is transferred between the VPLMN and TPLMN (e.g. within the same country). Furthermore, traffic routing within the country can result in the service being less failure prone, as it does not need to cross a country boundary.

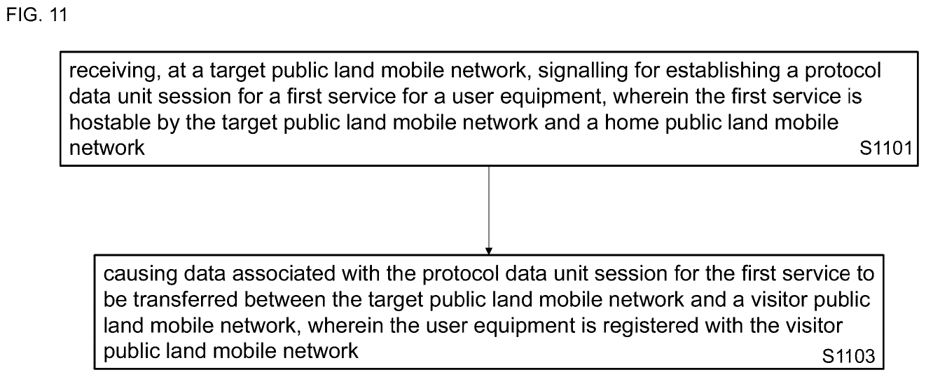

FIG. 11 shows an example method flow performed by an apparatus. The apparatus may be configured to operate as a TPLMN. The apparatus may be configured to operate as one or more network functions of a TPLMN. The apparatus may be configured to perform one or more functions of the one or more network functions of the TPLMN.

In S1101, the method comprises receiving, at a target public land mobile network, signalling for establishing a protocol data unit session for a first service for a user equipment, wherein the first service is hostable by the target public land mobile network and a home public land mobile network.

In S1103, the method comprises causing data associated with the protocol data unit session for the first service to be transferred between the target public land mobile network and a visitor public land mobile network, wherein the user equipment is registered with the visitor public land mobile network.

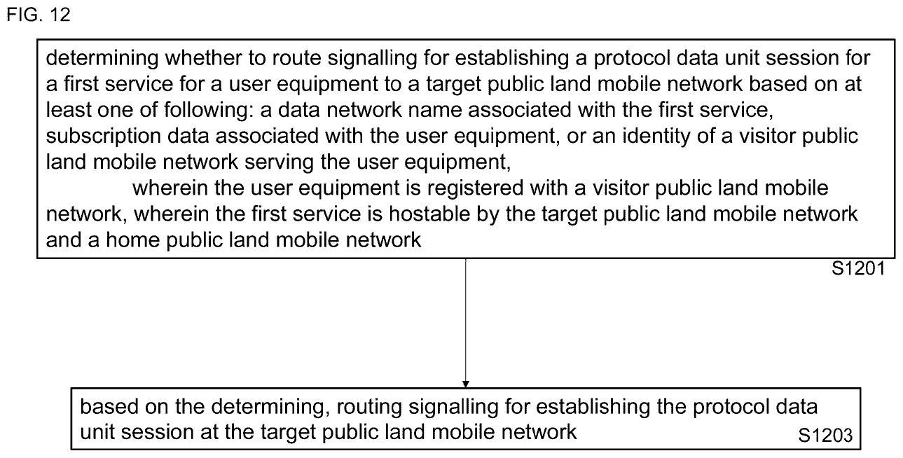

FIG. 12 shows an example method flow performed by an apparatus. The apparatus may be configured to operate as a HPLMN. The apparatus may be configured to operate as one or more network functions of a HPLMN The apparatus may be configured to perform one or more functions of the one or more network functions of the HPLMN.

In S1201, the method comprises determining whether to route signalling for establishing a protocol data unit session for a first service for a user equipment to a target public land mobile network based on at least one of following: a data network name associated with the first service, subscription data associated with the user equipment, or an identity of a visitor public land mobile network serving the user equipment, wherein the user equipment is registered with a visitor public land mobile network, wherein the first service is hostable by the target public land mobile network and a home public land mobile network.

In S1203, the method comprises, based on the determining, routing signalling for establishing the protocol data unit session at the target public land mobile network.

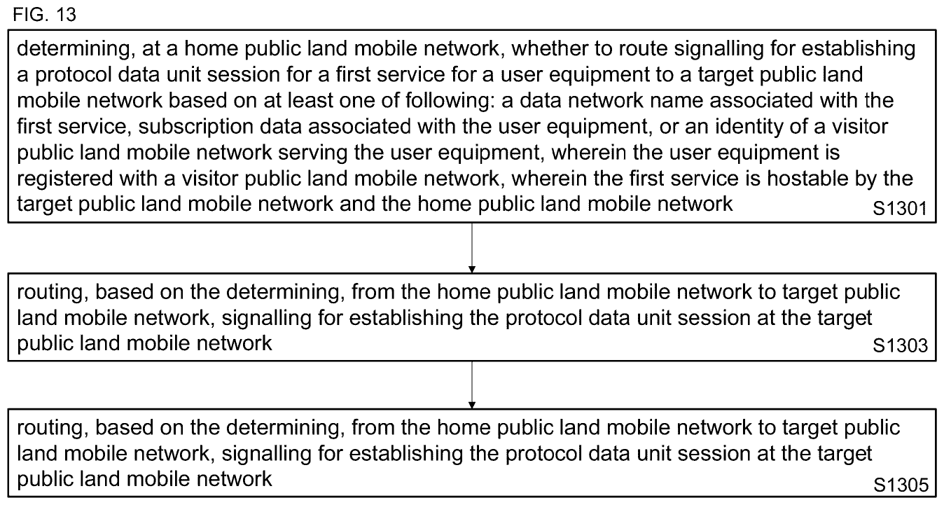

FIG. 13 shows an example method flow performed by a system. The system may comprise one or more apparatus of a TPLMN and one or more apparatus of a HPLMN. Each apparatus may be configured to operate as one or more network functions of a HPLMN and/or a TPLMN. Each apparatus may be configured to perform one or more functions of the one or more network functions of the HPLMN and/or the TPLMN.

In S1301, the method comprises determining, at a home public land mobile network, whether to route signalling for establishing a protocol data unit session for a first service for a user equipment to a target public land mobile network based on at least one of following: a data network name associated with the first service, subscription data associated with the user equipment, or an identity of a visitor public land mobile network serving the user equipment, wherein the user equipment is registered with a visitor public land mobile network, wherein the first service is hostable by the target public land mobile network and the home public land mobile network.

In S1303, the method comprises routing, based on the determining, from the home public land mobile network to target public land mobile network, signalling for establishing the protocol data unit session at the target public land mobile network.

In S1305, the method comprises routing, based on the determining, from the home public land mobile network to target public land mobile network, signalling for establishing the protocol data unit session at the target public land mobile network.

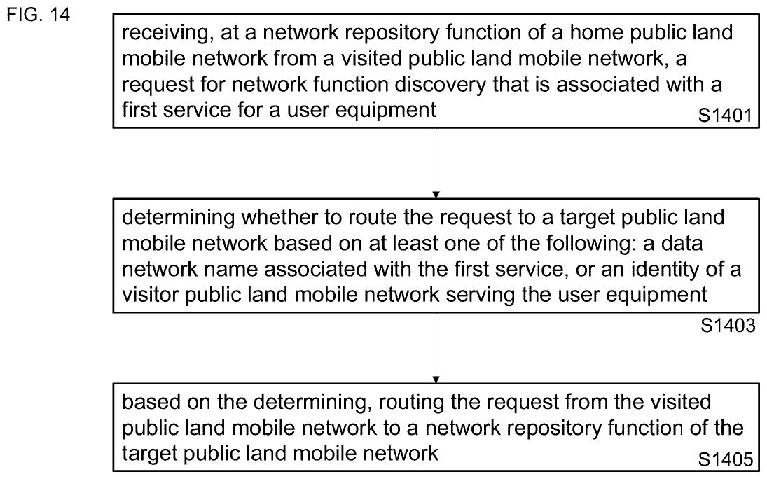

FIG. 14 shows an example method flow performed by an apparatus. The apparatus may be configured to operate as an NRF of a HPLMN. The apparatus may be configured to perform one or more functions of an NRF of a HPLMN.

In S1401, the method comprises receiving, at a network repository function of a home public land mobile network from a visited public land mobile network, a request for network function discovery that is associated with a first service for a user equipment.

In S1403, the method comprises determining whether to route the request to a target public land mobile network based on at least one of the following: a data network name associated with the first service, or an identity of a visitor public land mobile network serving the user equipment.

In S1405, the method comprises based on the determining, routing the request from the visited public land mobile network to a network repository function of the target public land mobile network.

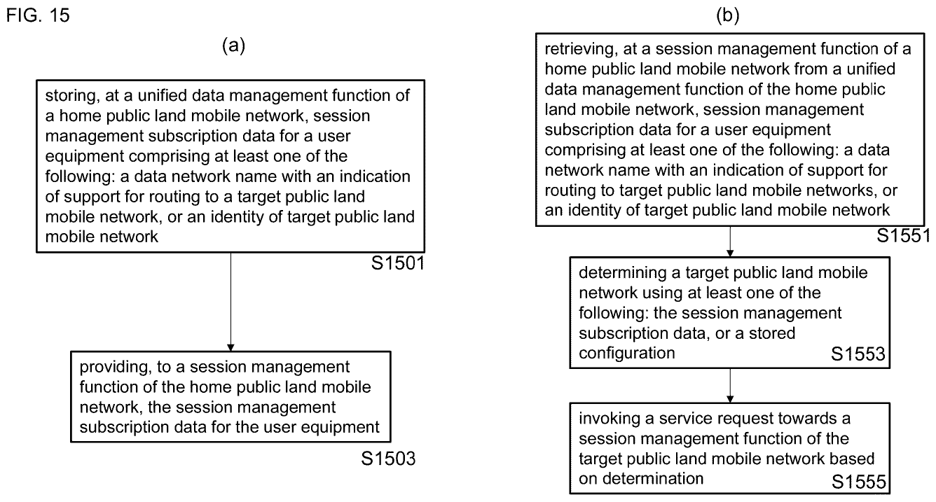

FIGS. 15a and 15b show example method flows each performed by an apparatus.

The apparatus of FIG. 15a may be configured to operate as a UDM of a HPLMN. The apparatus may be configured to perform one or more functions of a UDM of a HPLMN.

In S1501, the method comprises storing, at a unified data management function of a home public land mobile network, session management subscription data for a user equipment comprising at least one of the following: a data network name with an indication of support for routing to a target public land mobile network, or an identity of target public land mobile network.

In S1503, the method comprises providing, to a session management function of the home public land mobile network, the session management subscription data for the user equipment.

The apparatus of FIG. 15b may be configured to operate as an SMF of a HPLMN. The apparatus may be configured to perform one or more functions of an SMF of a HPLMN.

In S1551, the method comprises retrieving, at a session management function of a home public land mobile network from a unified data management function of the home public land mobile network, session management subscription data for a user equipment comprising at least one of the following: a data network name with an indication of support for routing to target public land mobile networks, or an identity of target public land mobile network.

In S1553, the method comprises determining a target public land mobile network using at least one of the following: the session management subscription data, or a stored configuration.

In S1555, the method comprises invoking a service request towards a session management function of the target public land mobile network based on determination.

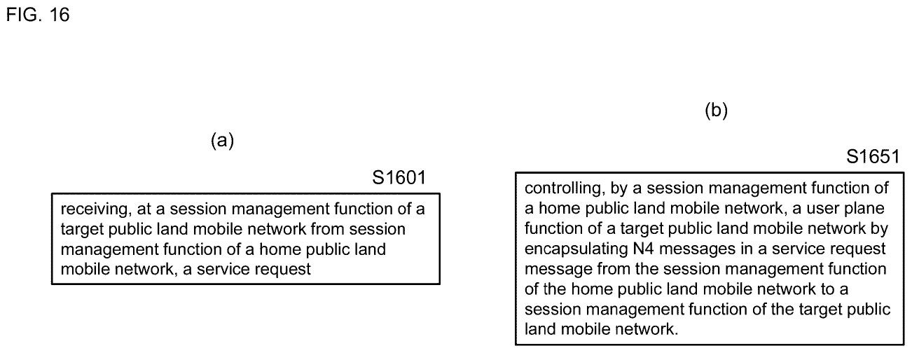

FIGS. 16a and 16b show example method flows each performed by an apparatus.

The apparatus of FIG. 16a may be configured to operate as an SMF of a TPLMN. The apparatus may be configured to perform one or more functions of an SMF of a TPLMN.

In S1601, the method comprises receiving, at a session management function of a target public land mobile network from session management function of a home public land mobile network, a service request.

The apparatus of FIG. 16b may be configured to operate as an SMF of a HPLMN. The apparatus may be configured to perform one or more functions of an SMF of a HPLMN.

In S1651, the method comprises controlling, by a session management function of a home public land mobile network, a user plane function of a target public land mobile network by encapsulating N4 messages in a service request message from the session management function of the home public land mobile network to a session management function of the target public land mobile network.

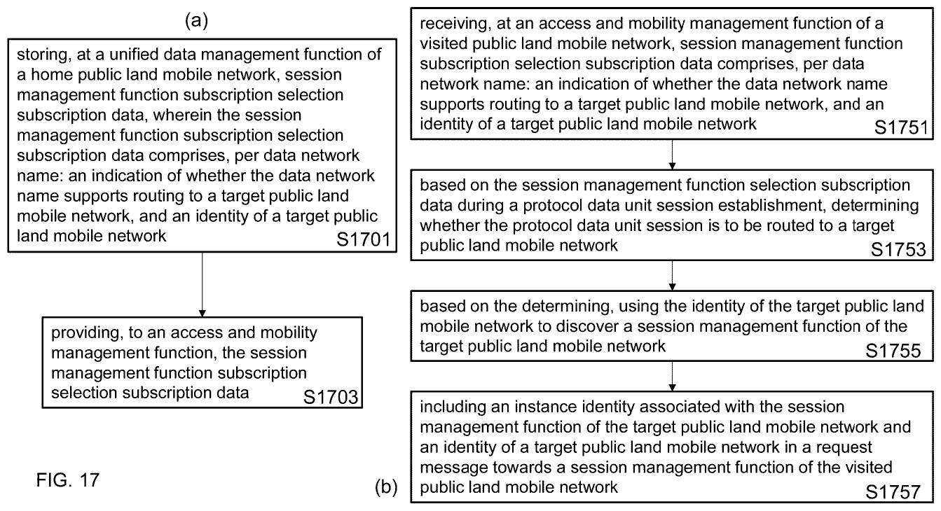

FIGS. 17a and 17b show example method flows each performed by an apparatus.

The apparatus of FIG. 16a may be configured to operate as a UDM of a TPLMN. The apparatus may be configured to perform one or more functions of a UDM of a TPLMN.

The apparatus of FIG. 17a may be configured to operate as an SMF of a HPLMN. The apparatus may be configured to perform one or more functions of an SMF of a HPLMN.

In S1701, the method comprises storing, at a unified data management function of a home public land mobile network, session management function subscription selection subscription data, wherein the session management function subscription selection subscription data comprises, per data network name: an indication of whether the data network name supports routing to a target public land mobile network, and an identity of a target public land mobile network.

In S1703, the method comprises providing, to an access and mobility management function, the session management function subscription selection subscription data.

The apparatus of FIG. 17a may be configured to operate as an AMF of a VPLMN. The apparatus may be configured to perform one or more functions of an AMF of a VPLMN.

In S1751, the method comprises receiving, at an access and mobility management function of a visited public land mobile network, session management function subscription selection subscription data comprises, per data network name: an indication of whether the data network name supports routing to a target public land mobile network, and an identity of a target public land mobile network.

In S1753, the method comprises based on the session management function selection subscription data during a protocol data unit session establishment, determining whether the protocol data unit session is to be routed to a target public land mobile network.

In S1755, the method comprises based on the determining, using the identity of the target public land mobile network to discover a session management function of the target public land mobile network.

In S1757, the method comprises including an instance identity associated with the session management function of the target public land mobile network and an identity of a target public land mobile network in a request message towards a session management function of the visited public land mobile network.

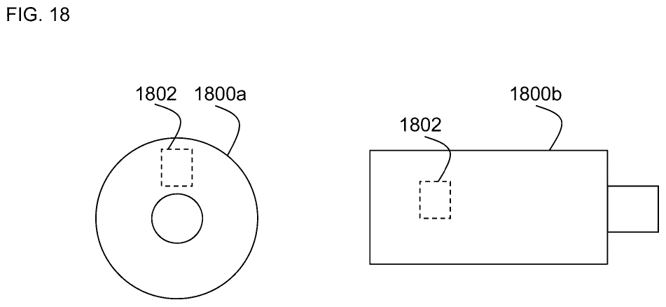

FIG. 18 shows a schematic representation of non-volatile memory media 1800a (e.g. computer disc (CD) or digital versatile disc (DVD)) and 1800b (e.g. universal serial bus (USB) memory stick) storing instructions and/or parameters 1102 which when executed by a processor allow the processor to perform one or more of the steps of the methods of FIGS. 11 to 17b.

It is noted that while the above describes various example embodiments, there are several variations and modifications which may be made without departing from the scope of the various example embodiments.

It will be understood that although the above concepts have been discussed in the context of a 5GS, one or more of these concepts may be applied to other cellular standards and systems.

The various example embodiments may thus vary within the scope of the claims. In general, some example embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the various example embodiments are not limited thereto. While the various example embodiments may be illustrated and described as block diagrams, flow charts, or using some other pictorial representation, it is well understood that these blocks, apparatus, systems, techniques or methods described herein may be implemented in, as illustrative and non-limiting examples, hardware, software, firmware, special purpose circuits or logic, general purpose hardware or controller or other computing devices, or some combination thereof.

The various example embodiments may be implemented by computer software stored in a memory and executable by at least one data processor of the involved entities or by hardware, or by a combination of software and hardware. Further in this regard, it should be noted that any procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The term “non-transitory”, as used herein, is a limitation of the medium itself (e.g. tangible, not a signal) as opposed to a limitation on data storage persistency (e.g. RAM vs ROM).

As used herein, “at least one of the following: <a list of two or more elements>” and “at least one of: <a list of two or more elements>” and similar wording, where the list of two or more elements are joined by “and”, or “or”, mean at least any one of the elements, or at least any two or more of the elements, or at least all of the elements.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as illustrative and non-limiting examples.

As used herein, the term “means for”, or “means configured to perform” (or similar) may be any means that are suitable for performing the feature. The “means” may be configured to perform one or more of the functions and/or method steps previously described. For example, the “means” may include one or more of: at least one processor, at least one memory, transceiver circuitry, antenna circuitry, etc. It should be understood that these are provided as illustrative and non-limiting examples.

Alternatively, or additionally some example embodiments may be implemented using circuitry. The circuitry may be configured to perform one or more of the functions and/or method steps previously described. That circuitry may be provided in the base station and/or in the communications device.

As used herein, the term “circuitry” may refer to one or more or all of the following example embodiments:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that utilizes software (e.g., firmware) for operation, but the software may not be present when it is not needed for operation.

This definition of circuitry applies to all uses of this term herein, including in any claims. As a further example, as used herein, the term circuitry also covers an implementation of merely a hardware circuit or processor (or multiple processors) or portion of a hardware circuit or processor and its (or their) accompanying software and/or firmware. The term circuitry also covers, for example integrated device. The term circuitry also covers, for example and if applicable to the particular claim element, a baseband integrated circuit or processor integrated circuit for a mobile device or a similar integrated circuit in a server, a cellular network device, or other computing or network device.

As used herein, the singular forms “a”, “an” and “the” are intended to include the plural forms as well, unless the context clearly indicates otherwise. For example, the expression “an apparatus” may thus refer to a single apparatus or two or more apparatus. It will be further understood that the terms “comprises”, “comprising”, “has”, “having”, “includes” and/or “including”, when used herein, specify the presence of stated aspects within an example embodiment, but do not preclude the presence or addition of one or more further aspects.

The foregoing description has, by way of illustrative and non-limiting example, provided a full and informative description of the various example embodiments. However, various modifications and adaptations may become apparent to those skilled in the relevant arts in view of the foregoing description, when read in conjunction with the accompanying drawings and the claims. However, all such and similar modifications of the teachings will still fall within the scope the various example embodiments described herein.

1. An apparatus comprising at least one processor, and at least one memory storing instructions that, when executed by the at least one processor, cause the apparatus to perform:
receiving, at a target public land mobile network, signalling for establishing a protocol data unit session for a first service for a user equipment, wherein the first service is hostable by the target public land mobile network and a home public land mobile network; and
causing data associated with the protocol data unit session for the first service to be transferred between the target public land mobile network and a visitor public land mobile network, wherein the user equipment is registered with the visitor public land mobile network.

2. The apparatus according to claim 1, wherein the receiving comprises:
receiving, from the home public land mobile network, a network function discovery request.

3. The apparatus according to claim 1, wherein the instructions, when executed by the at least one processor, further cause the apparatus to perform:
providing, to the visited public land mobile network, information about a session management function of the target public land mobile network for the establishment of the protocol data unit session.

4. The apparatus according to claim 1, wherein the receiving comprises:
receiving, at a session management function of the target public land mobile network from a session management function of the home public land mobile network, a service request message comprising at least one of the following: information associated with the protocol data unit session establishment request, or subscription data associated with the user equipment.

5. The apparatus according to claim 1, wherein the receiving comprises:
receiving, at a session management function of the target land mobile network, a protocol data unit session establishment request message from a session management function of the home public land mobile network;
and wherein the instructions, when executed by the at least one processor, further cause the apparatus to perform:
selecting a user plane function of the target public land mobile network to serve the protocol data unit session; and
responding to the session management function of the home public land mobile network with an indication of the selected user plane function of the target public land mobile network.

6. The apparatus according to claim 1, wherein the receiving, at a target public land mobile network, signalling for establishing a protocol data unit session for a first service for a user equipment comprises:
receiving, from the visited public land mobile network, the signalling for establishing a protocol data unit session for a first service for a user equipment.

7. The apparatus according to claim 1, wherein the instructions, when executed by the at least one processor, further cause the apparatus to perform:
retrieving, from a unified data management function of the home public land mobile network, session management subscription data comprising at least one of the following, per data network name: an indication of whether the data network name supports roaming value added services routing to a target public land mobile network, or an identity of the target public land mobile network.

8. An apparatus comprising at least one processor, and at least one memory storing instructions that, when executed by the at least one processor, cause the apparatus to perform:
determining whether to route signalling for establishing a protocol data unit session for a first service for a user equipment to a target public land mobile network based on at least one of following: a data network name associated with the first service, subscription data associated with the user equipment, or an identity of a visitor public land mobile network serving the user equipment,
wherein the user equipment is registered with a visitor public land mobile network, wherein the first service is hostable by the target public land mobile network and a home public land mobile network; and
based on the determining, routing signalling for establishing the protocol data unit session at the target public land mobile network.

9. The apparatus according to claim 8, wherein the routing signalling for establishing the protocol data unit session comprises:
forwarding, to the target public land mobile network from the visitor public land mobile network, a network function discovery request based on at least one of following: a data network name associated with the first service, subscription data associated with the user equipment, or an identity of a visitor public land mobile network serving the user equipment.

10. The apparatus according to claim 8, wherein the instructions, when executed by the at least one processor, further cause the apparatus to perform:
using, at a network repository function of the home public land mobile network, a stored configuration comprising an indication of a serving public land mobile network and a data network name mapped to the target public land mobile network.

11. The apparatus according to claim 8, wherein the instructions, when executed by the at least one processor, further cause the apparatus to perform:
receiving, at a session management function of the home public land mobile network from the visited public land mobile network, a protocol data unit session establishment request for the user equipment;
based on the protocol data unit session establishment request, providing, to a session management function of the target public land mobile network, a service request message comprising at least one of the following: information associated with the protocol data unit session establishment request, or subscription data associated with the user equipment.

12. The apparatus according to claim 8, wherein the instructions, when executed by the at least one processor, further cause the apparatus to perform:
controlling, by a session management function of the home public land mobile network, a user plane function of the target public land mobile network by encapsulating an N4 message in a service request message from the session management function of the home public land mobile network to a session management function of the target public land mobile network.

13. The apparatus according to claim 8, wherein the instructions, when executed by the at least one processor, further cause the apparatus to perform:
storing, at a unified data management function of the home public land mobile network, session management subscription data for the user equipment comprising at least one of the following: a data network name with an indication of support for roaming value added service routing, or a target public land mobile network identity with an indication of support for roaming value added service routing.

14. The apparatus according to claim 8, wherein the instructions, when executed by the at least one processor, further cause the apparatus to perform:
storing, at a unified data management function of the home public land mobile network, session management function selection subscription data comprising at least one of the following, per data network name: an indication of whether the data network name supports roaming value added services routing to a target public land mobile network, or an identity of the target public land mobile network; and
providing, based on a received request from a session management function of the target public land mobile network, session management function selection subscription data for the user equipment to the target land mobile network.

15. An apparatus comprising: at least one processor, and at least one memory storing instructions that, when executed by the at least one processor, cause the apparatus to perform:
receiving, at a network repository function of a home public land mobile network from a visited public land mobile network, a request for network function discovery that is associated with a first service for a user equipment;
determining whether to route the request to a target public land mobile network based on at least one of the following: a data network name associated with the first service, or an identity of a visitor public land mobile network serving the user equipment; and
based on the determining, routing the request from the visited public land mobile network to a network repository function of the target public land mobile network.
